(19) United States
(12) Patent Application Publication
(10) Pub. No.: US 2016/0358428 A1
(43) Pub. Date: Dec. 8, 2016

(54) COMPLIANCE TACTILE FEEDBACK DEVICE

(71) Applicant: UNIVERSITY OF UTAH RESEARCH FOUNDATION, Salt Lake City, UT (US)

(72) Inventors: William R. Provancher, Fremont, CA (US); Seiedmuhammad Yazdian, Salt Lake City, UT (US); Andrew J. Doxon, Urbandale, IA (US)

(21) Appl. No.: 15/117,911

(22) PCT Filed: Feb. 12, 2015
(86) PCT No.: PCT/US15/15716

§ 371 Date: Aug. 10, 2016

Related U.S. Application Data
(60) Provisional application No. 61/939,677, filed on Feb. 13, 2014.

(51) Int. Cl. G08B 6/00; G06F 3/01

(52) U.S. Cl. CPC G08B 6/00; G06F 3/016; G06F 3/011

(57) ABSTRACT

Devices, systems, and methods for communicating tactile information to a user about a remote or virtual environment may include providing a device having a plurality of contact surfaces that are connected to one another. One or more actuators may move the contact members relative to one another in order to communicate tactile information to a user. Tactile information may be communicated by replicating the compliance of a remote or virtual object.

### PRIORITY

The present application claims priority to and the benefit of U.S. Provisional Patent Application No. 61/939,677 entitled “COMPLIANCE TACTILE FEEDBACK DEVICE” filed Feb. 13, 2014, the disclosure of which is incorporated herein by reference in its entirety.

### BACKGROUND OF THE DISCLOSURE

1. The Field of the Invention

Generally, this disclosure relates to tactile feedback devices. More specifically, the present disclosure relates to a tactile feedback device for replicating compliance of a surface in a remote or virtual environment.

2. Background and Relevant Art

One of the most important aspects of identifying and discriminating objects is the perception of compliance of a surface or material of the object. In particular, compliance plays a unique role in discriminating hidden or subsurface features for which visual information is insufficient, such as identifying ripe fruit, locating an object below a covering, or identifying subcutaneous features during a medical procedure. For example, compliance of a surface may be crucial in identifying an abnormal growth amongst healthy tissue. While robotic or automated instruments allow a user to manipulate physical objects in a remote or virtual environment, the user's interaction with the physical object and/or its environment is insufficiently communicated to the user. Under such conditions, a user may need to rely primarily on visual information and forego the information provided by tactile engagement, such as compliance.

Compliance is a perception of “softness” and may be experienced through an interaction between a subject and another surface. The interaction may be nonlinear and viscoelastic. A person's perception of compliance may be a combination of tactile information and kinesthetic information. Tactile information includes information conveyed through the direct interaction between, for example, the fingerpad and the surface, such as the relationship between the applied force and the contact profile of the fingerpad and the surface. Kinesthetic information includes the relationship between the force applied by a person's finger and the finger's rigid displacement.

Kinesthetic information alone is insufficient to communicate the compliance of an object. For example, kinesthetic information alone will not properly convey to a subject a discernable difference between a piano key and an inflated balloon. Therefore, mere displacement of a person's finger by a feedback device may be insufficient to communicate compliance information from a virtual or remote environment to a person.

### BRIEF SUMMARY OF THE DISCLOSURE

Embodiments of the present disclosure address one or more of the foregoing or other problems in the art with apparatuses, systems, and methods for communicating compliance information of a remote or virtual environment to a user.

In an embodiment, a tactile feedback device includes a housing with a plurality of contact members connected to one another about an axis and connected to the housing. The device also includes an actuator connected to at least one of the contact members through a mechanical linkage that allows the actuator to move the contact member about the axis.

In another embodiment, a tactile feedback device includes a first pair of contact members and a second pair of contact members. Each pair of contact members defines a first and second contact surface, respectively. The first pair of contact members and second pair of contact members are connected to a housing. The device includes a first actuator configured to move at least one of the contact members and a second actuator also configured to move at least one of the contact members. In a further embodiment, the first and second contact surfaces are oriented in substantially opposing directions.

In yet another embodiment, a method for communicating tactile information is presented. The method includes providing a device including a housing with a plurality of contact members connected to one another about an axis and connected to the housing. The device also includes an actuator connected to at least one of the contact members through a mechanical linkage that allows the actuator to move the contact member about the axis. The method also includes measuring a force applied to the contact surface (e.g., with a force sensor or using a spring plus displacement sensor) and using that force to calculate a rate and amount of movement of the contact members. The method further includes moving the contact members according to the rate and amount of movement calculated.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. For better understanding, like elements have been designated by like reference numbers throughout the various accompanying figures. Understanding that these drawings depict only typical embodiments of the disclosure and are not therefore to be considered to be limiting of its scope, the disclosure will be described and explained with additional specificity and detail through the use of the accompanying drawings in which:

FIG. 1 is a schematic diagram depicting the communication of tactile information to a user using a movable contact surface;

FIG. 2 is a schematic diagram depicting the communication of tactile information to a user using a movable contact surface and spring;

FIG. 3 is a schematic diagram depicting the communication of tactile information to a user using two movable contact surfaces and spring;

FIG. 4 is a perspective view of a compliance tactile feedback device in accordance with the present disclosure;

FIG. 5 is a side view of the compliance tactile feedback device of FIG. 4;

FIG. 6 is a perspective view of another compliance tactile feedback device in accordance with the present disclosure;

FIG. 7 is a side view of the compliance tactile feedback device of FIG. 6;

FIG. 8 is a perspective view of the compliance tactile feedback device shown in FIGS. 4 and 5 that includes an example housing in accordance with the present disclosure;

FIG. 9-1 is a schematic side view of a compliance tactile feedback device associated with a user's finger that includes force measurement;

FIG. 9-2 is a schematic side view of a compliance tactile feedback device communicating compliance information to a user's finger in response to the user's measured applied finger force;

FIG. 9-3 is a schematic side view of a compliance tactile feedback device communicating compliance information to a user's finger in response to the user's measured applied finger force as the user continues to apply a force greater than was applied in FIG. 9-2;

FIG. 10 is a perspective view of the compliance tactile feedback device of FIG. 8 further including a force sensor and compressible assembly;

FIG. 11 is a perspective view of a compliance tactile feedback device having more than one contact surface in accordance with the present disclosure; and

FIG. 12 is a flowchart depicting a method of use of a compliance tactile feedback device in accordance with the present disclosure.

### DETAILED DESCRIPTION

One or more implementations of the present disclosure relate to tactile feedback. In particular, implementations of the present disclosure relate to the communication of compliance information to a user through tactile simulation of the compliance of remote or virtual surfaces.

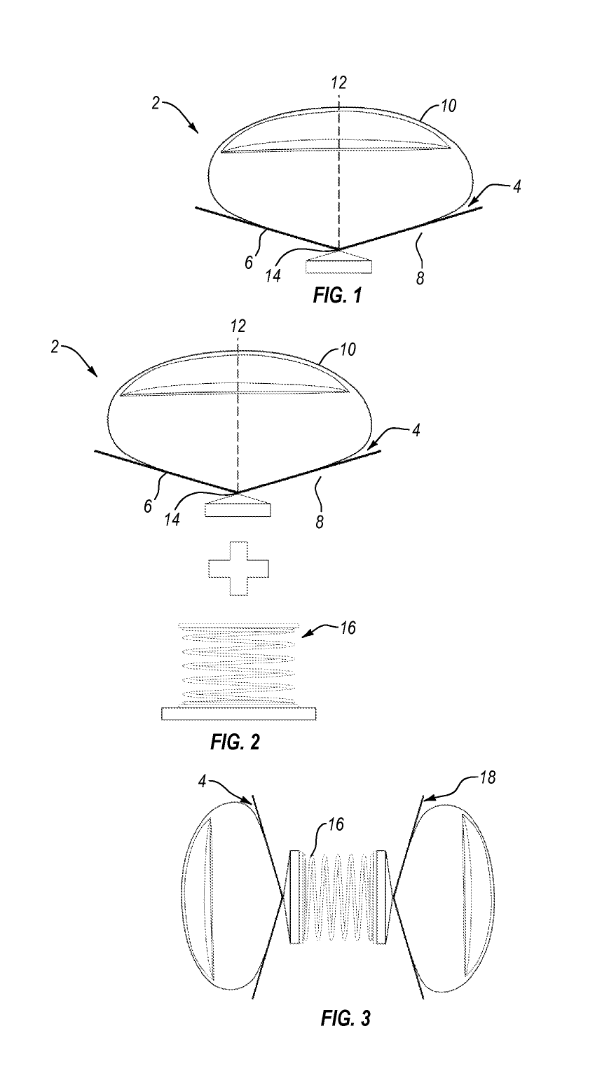

A compliance tactile feedback device 2 may include a contact surface capable of simulating compliance characteristics of a remote (distant) and/or virtual surface. As shown in the schematic diagram of FIG. 1, the contact surface 4 may include one or more members 6, 8 that contact a contact area of a user's finger 10 and may move relative to the finger 10 to communicate tactile information to the user. While FIG. 1 depicts the device in communication with a user's finger 10, any references to a user's finger in the present disclosure may be considered illustrative, and the device should not be understood to be so limited. The orientation of the user's finger 10 relative to the contact surface is not restricted to the orientation shown in FIG. 1. Furthermore, in other embodiments, the device may be in communication with other areas of a user's body, such as a palm of a user's hand, user's foot, or any other portion of the body that may perceive tactile information.

In some embodiments, the members 6, 8 may be connected directly to one another near and/or at a centerline 12 of the user's finger 10, such as with a hinged connection 14. In some embodiments, the hinged connection 14 may allow an actuator to rotate the members 6, 8 toward or away from one another, simulating a range of compliances. In another embodiment, more than one actuator may move the members 6, 8 independently, allowing for the simulation of uneven surfaces, edge effects, to compensate for non-ideal mounting of the device, or combinations thereof.

Additionally, a compliance tactile feedback device 2 may be connected to or include a mechanism to allow compressibility of the contact surface 4, such as a coil spring 16 depicted in the schematic diagram of FIG. 2, a leaf spring, a layer of resilient material, other resilient member, or combinations thereof. The spring 16 may alter a user's perception of the compliance information provided by the device by shifting the user's perception of the surface's compliance to simulate softer, more compliant values. That is, since both the spring 16 and the compliance tactile feedback device 2 have a perceived stiffness (stiffness being the inverse of compliance), if a compliance tactile feedback device 2 is mounted on a spring 16, this results in the superposition of the perceived compliance of the spring 16 and compliance tactile feedback device 2. The stiffness decreases (i.e., feels softer) when placing two springs in series, therefore, the resulting stiffness is reduced when the compliance tactile feedback device 2 is mounted on a spring 16 (stiffness, K, for springs in series obeys the following relationship: 1/K_{Series}=1/K₁+1/K₂ or K_{Series}=(K₁ K₂)/(K₁+K₂); so if K₁ and K₂ were each equal to 1000 N/m, then K_{Series} is equal to 500 N/m, and compliance, C, is the reciprocal of stiffness C=1/K).

Hence, a spring 16 can be used to extend the range of compliance that can be rendered by the compliance tactile feedback device 2 to include stiffness values below what would be possible when only using the compliance tactile feedback device 2 by itself (i.e., the spring 16 allows softer surfaces to be simulated). When mounted on the spring 16, the maximum perceived stiffness value that can be simulated with the compliance tactile feedback device 2 is the stiffness of the spring 16. The lower bound of stiffness is determined by the superimposed stiffness value of the spring 16 and the minimum stiffness value that can be portrayed with the compliance tactile feedback device 2. The minimum stiffness value that can be simulated with the compliance tactile feedback device may be limited by the speed of the actuators chosen to actuate the contact surface 4. Surface stiffness values between these upper and lower bounds may be simulated by varying the rate and/or amount with which the contact surface 4 is actuated.

As shown in FIG. 3, a compliance tactile feedback device 20 may also include a plurality of contact surfaces 4, 18 capable of simulating compliance characteristics of a remote and/or virtual surface or object. For example, a compliance tactile feedback device 20 may have contact surfaces oriented in substantially opposite directions allowing for replication of compliant objects held between, for example, a forefinger and a thumb. FIG. 3 depicts a spring 16 disposed between the contact surfaces 4, 18, but the device may provide tactile information independent of the spring 16.

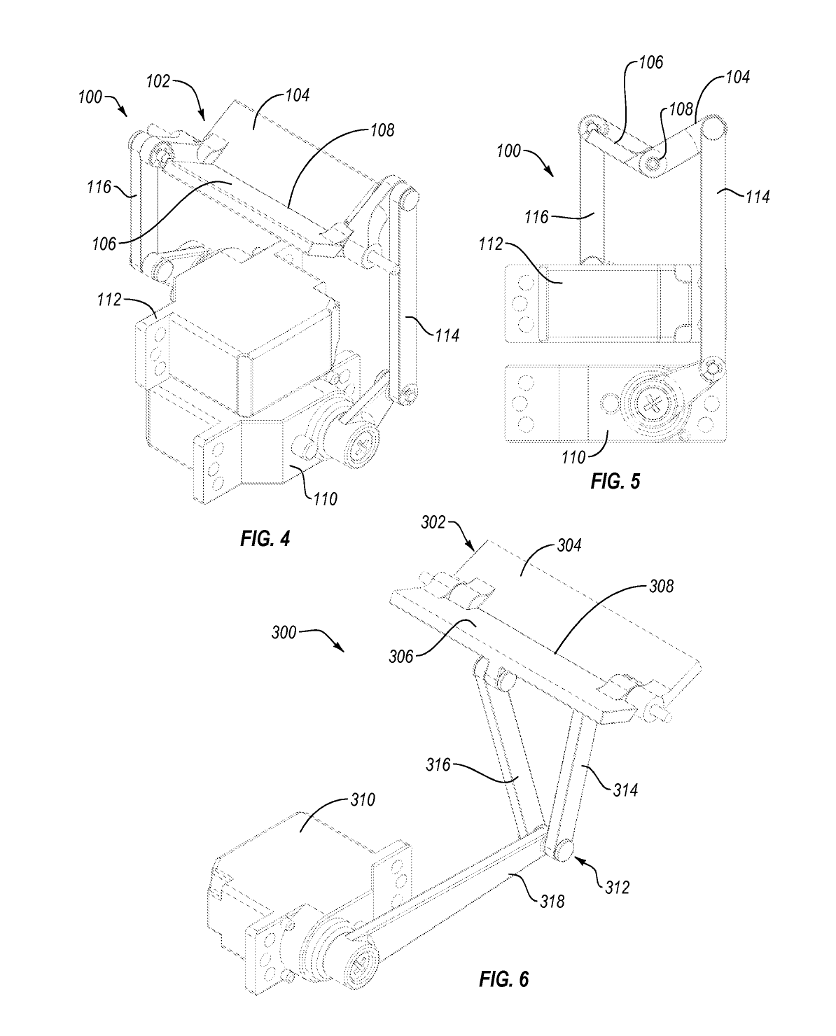

FIGS. 4 and 5 illustrate an embodiment of a compliance tactile feedback device 100 including a contact surface 102 that may be altered by moving a first contact member 104 and a second contact member 106 relative to one another. The first and second contact members 104, 106 may be pivotally connected about an axis 108. In some embodiments, the contact members 104, 106 may be rigid members. In other embodiments, the contact members 104, 106 may be resilient members. In further embodiments, the contact members 104, 106 may be elastically deformable members. The first and second contact members 104, 106 are depicted in FIG. 4 as being substantially flat, however in other embodiments, the contact members 104, 106 may be curved surfaces and/or may include a textured surface.

The axis 108 allows the first contact member 104 and second contact member 106 to pivot relative to one another while the axis 108 at or near the center of the contact surface 102 remains relatively stationary. The stationary axis 108 may allow a user's fingerpad to rest on the contact surface 102 and remain relatively stationary while the movement of the first contact member 104 and second contact member 106 communicates tactile information to the user. The stationary fingerpad isolates the tactile information from kinesthetic information, allowing for discrete communication of tactile information to the user.

The axis 108, depicted in FIGS. 4 and 5, includes a hinge that allows relative rotation of the first contact member 104 and the second contact member 106 about the axis 108. However, in other embodiments, the axis 108 may include a flexible connection between the first contact member 104 and the second contact member 106, such as an elastically deformable connection (e.g., a living hinge). In further embodiments, the axis 108 may include more than one axis parallel and adjacent to one another, such as with parallel and adjacent hinges.

In the embodiment of FIGS. 4 and 5, the first contact member 104 is connected to a first actuator 110 and the second contact member 106 is connected to a second actuator 112. The first and second actuators 110, 112 may be servo motors, as shown. In another embodiment, the first and/or second actuators 110, 112 may be electromagnetic, piezoelectric, electro-active polymers, hydraulic, pneumatic, or other types of motive devices. The first actuator 110 can be connected to the first contact member 104 through a first mechanical linkage 114. As is best seen in FIG. 5, the first mechanical linkage 114 uses a linkage to translate rotation of the first actuator 110 through the first mechanical linkage 114 to rotate the first contact member 104 a proportional amount. In another embodiment, the first mechanical linkage 114 may include a four-bar mechanical linkage, a screw drive, or other suitable linkage to translate motion of the first actuator 110 to move the first contact member 104. Similarly, the second actuator 112 can be connected to the second contact member 106 through a second mechanical linkage 116. The second mechanical linkage 116 also uses a linkage to translate rotation of the second actuator 112 through the second mechanical linkage 116 to rotate the second contact member 106 a proportional amount. In another embodiment, the second mechanical linkage 116 may include a four-bar mechanical linkage, a screw drive, or other suitable linkage to translate motion of the second actuator 112 to move the second contact member 106.

The first actuator 110 and second actuator 112 may operate in unison, providing a symmetrical contact surface 102, or the first actuator 110 and the second actuator 112 may operate independently to move the first contact member 104 and second contact member 106 non-symmetrically. For example, the first contact member 104 may move at a different rate than the second contact member 106. A symmetrical contact surface 102 may allow for the presentation of tactile information corresponding to a substantially uniformly compliant surface, such as pressing against a foam pad. A non-symmetrical contact surface 102, in contrast, may allow for the presentation of tactile information corresponding to non-uniform surfaces, such as material edges or subsurface elements. For example, a user may palpate across a rib during surgery and independent actuation may allow for the contact surface to more accurately simulate the user's fingerpad passing over a bone located beneath the skin of a patient. The contact surface 102 could be driven to present at convex ridge by tilting the contact members 104 and 106 downward as the user slides their fingers over a rib, while the contact surface would be actuated into a concave shape, with the contact members 104 and 106 tilted upward as shown in FIG. 1 when presenting compliant skin, biological tissue, or organs. Additionally, independent movement of the first contact member 104 and the second contact member 106 may aid in compensating for non-ideal mounting of the compliance tactile feedback device 100.

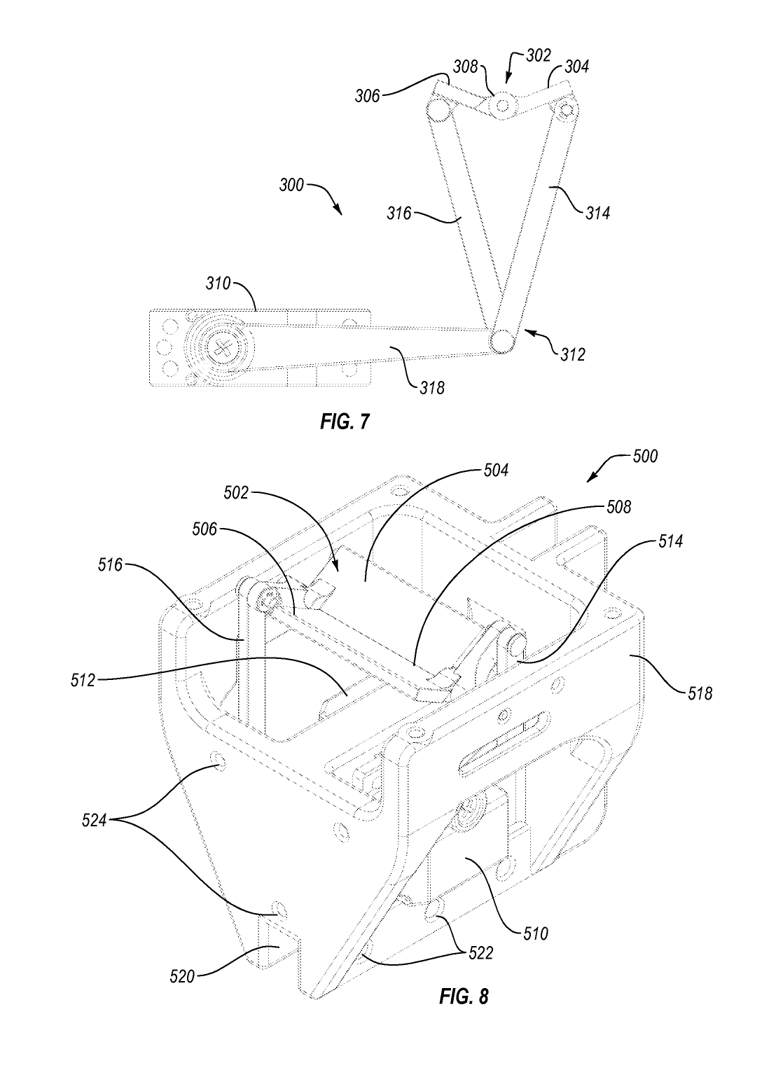

FIGS. 6 and 7 depict another embodiment of a compliance tactile feedback device 300 that includes a contact surface 302 having a first contact member 304 and a second contact member 306 connected about an axis 308, and both the first contact member 304 and second contact member 306 are controlled by a single actuator 310. The actuator 310 moves the first contact member 304 and second contact member 306 together through a mechanical linkage 312. The mechanical linkage 312 can connect to the first contact member 304 by a first slide arm 314 and to the second contact member 306 by a second slide arm 316. The first and second linkage arms 314, 316 can be connected to the actuator 310 by a lever arm 318. The lever arm 318 may translate the rotation of the actuator 310 into substantially linear movement of the first linkage arm 314 and second linkage arm 316 perpendicular to the lever arm 318. In another embodiment, the lever arm 318 may be extendable, such as a telescopic arm, such that the actuator may rotate the level arm 318 through a larger arc while the movement of the first linkage arm 314 and second linkage arm 316 remains substantially linear. In another embodiment, the actuated linear motion of the junction of first linkage arm 314 and second linkage arm 316 that pushes and pulls the first linkage arm 314 and second linkage arm 316 toward and away from the contact surface 302 may be provided by solenoid, linear motor, leadscrew, rack and pinion, capstan, or similar linear actuator mechanism.

Similar to the compliance tactile feedback device 100 of FIGS. 4 and 5, the compliance tactile feedback device 300 of FIGS. 6 and 7 includes first and second contact members 304, 306 that are connected together about an axis 308. The contact members 304, 306 may be rigid members, resilient members, elastically deformable members, or combinations thereof. The first and second contact members 304, 306 depicted in FIGS. 6 and 7 are substantially flat, however in other embodiments, the contact members 304, 306 may be curved surfaces or may include a textured surface.

Also similar to the compliance tactile feedback device 100 of FIGS. 4 and 5, the axis 308 depicted in FIGS. 6 and 7 is a hinge that allows relative rotation of the first contact member 304 and the second contact member 306 about the axis 308. However, in other embodiments, the axis 308 may be a flexible connection between the first contact member 304 and the second contact member 306, such as an elastically deformable connection. In further embodiments, the axis 308 may be more than one axis parallel and adjacent to one another, such as with parallel and adjacent hinges.

FIG. 8 illustrates another embodiment of a compliance tactile feedback device 500. The compliance tactile feedback device 500 includes the compliance tactile feedback device 100 of FIGS. 4 and 5 mounted within a housing 518 such that the compliance tactile feedback device 500 may be connected to other devices. The compliance tactile feedback device 500 includes a similar or the same structure to the compliance tactile feedback device 100 of FIGS. 4 and 5 or variants described in association therewith, such as having a contact surface 502 including first and second contact members 504, 506 connected about an axis 508, which are linked to first and second actuators 510, 512, respectively. In addition, the compliance tactile feedback device 500, however, includes a housing 518, which includes a channel 520 and cross-bores 522, as well as side connectors 524, which enable the housing 518 to affix to other devices. In another embodiment, the housing 518 may include more or fewer connectors than the housing 518 depicted in FIG. 8. The other devices to which the housing 518 may connect can include haptic feedback (e.g., force feedback) devices, control devices for remote or virtual environments, a force sensor, additional compliance tactile feedback devices, or combinations thereof in accordance with the present disclosure.

For example, the compliance tactile feedback device 500 may be connected to a haptic feedback (e.g., force feedback) device allowing kinesthetic information to be simulated in conjunction with the tactile information of the compliance tactile feedback device 500. The combination of the tactile and kinesthetic information can provide an increased ability for a user to discriminate and identify objects or surfaces, virtual or remote, which the compliance tactile feedback device 500 renders. The haptic device may simulate a programmable or variable spring, in place of the physical spring 16 shown in FIGS. 2 and 3. This allows greater flexibility to present compliance information to a user through a combination of tactile and kinesthetic feedback. Similarly, more than one compliance tactile feedback device 500 may be connected adjacent to one another using, for example, the side connectors 524 to create an array of compliance tactile feedback devices 500. An array of compliance tactile feedback devices 500 may allow each finger or multiple points along a finger to receive different tactile information about the remote or virtual environment. Therefore, an array may enable even greater accuracy in simulating surfaces, such as being able to more accurately replicating the ribs of a remote patient, by allowing a user to examine a larger area of the patient by “feeling” multiple ribs at once or perceiving a rib with multiple fingers while palpating across the patient.

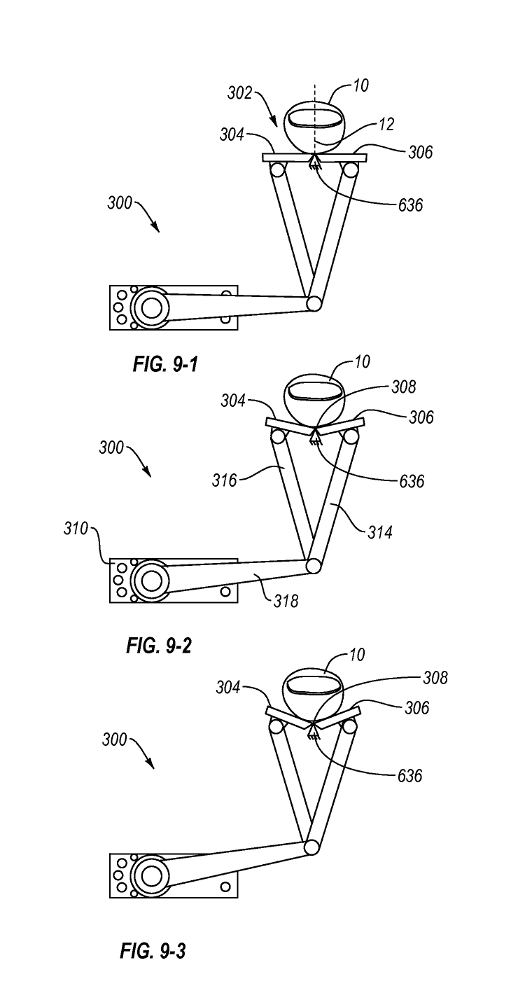

The tactile information may be communicated to a user as shown schematically in FIGS. 9-1 through 9-3. FIG. 9-1 depicts a compliance tactile feedback device 300 similar to that depicted in FIGS. 6 and 7 in association with a user's finger 10, although it should be understood that communication of tactile information may be accomplished with any suitable embodiment of a compliance tactile feedback device incorporating the elements described herein. The user's finger 10 rests on the contact surface 302 of the compliance tactile feedback device 300 and an axial centerline 12 of the finger 10 approximately aligns with the axis 308. In other embodiments, the contact surface 302 may be configured to contact a user's finger 12 at other orientations, such as a 90-degree orientation to the axis 308. The contact surface 302 remains horizontal when no force is applied. As the finger 10 applies force to the contact surface 302, the force sensor 636 measures the amount of force applied and the force measurement is used to calculate the amount of angular deflection of the contact members 304, 306. The force sensor 636, while shown schematically in direct communication with the contact surface 302, may be disposed in any location suitable to measure the force applied to the contact surface 302. Other suitable locations for a force sensor could include the surface of the contact members 304 and 306, the base of the housing 518 (FIG. 8), at the joints of the axis 308 and linkages 314, 316, 318, or above or below a spring 16 (FIGS. 2 and 3), if used. In another example, the force sensor 636 may be replaced with a potentiometer or hall effect sensor that can directly measure the amount of linear/translational or angular deflection of the compliance tactile feedback device 300. In yet another example, the force sensor 636 may comprise a force sensing resistor (“FSR”) fabricated using piezoresistive ink. A force sensor 636 may also be implemented by indirectly measuring the applied force, by measuring the translational or rotational displacement of a spring or elastic element, e.g., using IR optical emitter-detector pair, linear potentiometer or encoder, capacitive sensor, hall effect sensor, etc.

Controlling the rate of deflection of the contact surface 302 as a function of the force applied to the contact surface 302 may be used to communicate tactile information regarding compliance. For example, the tilting rate of the contact surface 302 could be controlled to provide a prescribed angle between the contact members 304 and 306 as a function of the applied force (e.g., in degrees per Newton of applied force or by some other linear or non-linear function of applied force). The amount and rate of deflection may increase when simulating a higher compliance (lower stiffness) material for a given input force. Conversely, the amount and rate of deflection may decrease when simulating a lower compliance (higher stiffness) material for a given input force. For example, the calculated amount and rate of deflection may be higher when replicating a high compliance surface, such as a pillow than the calculated amount and rate of deflection when replicating a low compliance surface, such as an electronics enclosure. When no force is applied, the contact surface could be flat, as shown in FIG. 9-1. As more force is applied, the contact members 304, 306 of the contact surface 302 rotate upwards, as shown in FIGS. 9-2 and 9-3. The higher tilting displacement shown in FIG. 9-3 relative to FIG. 9-2 could be as a result of simulating a higher compliance (softer) surface in FIG. 9-3 or a result of greater applied force in FIG. 9-3, relative to FIG. 9-2.

As shown in FIG. 9-2, as the finger 10 applies a force to the compliance tactile feedback device 300, the force sensor 636 measures the applied force, and the actuator 310 rotates the lever arm 318 to move first and second linkage arms 314, 316 toward the finger 10. The first and second linkage arms 314, 316 cause the first and second contact members 304, 306 to deflect toward the finger 10 while rotating about the axis 308. The axis 308 remains stationary relative to a base (not shown in FIGS. 9-1 to 9-3), such as housing 518 depicted in FIG. 8. FIG. 9-3 shows the state of the contact surface 302 after additional force has been applied, relative to the state shown in FIG. 9-2. Note that the contact members 304, 306 begin to tilt and wrap around the sides of the user's finger as more force is applied in the progression from FIG. 9-1 to FIG. 9-3, which mimics what naturally occurs when someone pushes his/her finger into a compliant material, such as polyurethane foam. Hence, the upward tilting of the contact members as one pushes into the contact surface 302 creates the illusion of a compliant object.

As depicted in FIG. 9-3, because the axis 308 remains stationary, the finger 10 remains stationary and the compliance tactile feedback device 300 conveys tactile information independently of kinesthetic information. Since the compliance tactile feedback device 300 may not impose motion on the finger, it also has the advantage that it is unlikely to induce feedback instabilities when it is used in conjunction with a control system. As mentioned earlier, a compliance tactile feedback device may be employed with other devices, including a haptic feedback device capable of providing kinesthetic information, as well.

While FIGS. 9-1 through 9-3 depict the movement of the first and second contact members 304, 306 toward the finger 10 to simulate the compression or a compliant surface and/or object, it has also been demonstrated that movement of the first and second contact members 304, 306 away from the finger 10 may allow for simulation of some compliant surfaces and/or objects, as well as providing unique functionality. A method of providing tactile cues to the user may be performed by moving the first and second contact members 304, 306 through a range of positions as shown in FIGS. 9-1 through 9-3 in the reverse order. For example, the compliance tactile feedback device 300 may be provided to a user with the first and second contact members 304, 306 oriented as shown in FIG. 9-3. As the force applied by the user increases, the force (or displacement) sensor 636 may relay that information to the actuator 310 to move the first and second contact members 304, 306 downward toward the orientation shown in FIG. 9-2 and/or FIG. 9-1.

For example, the first and second contact members 304, 306 may begin in a V-shaped orientation (i.e., the first and second contact members 304, 306 are held at an relative orientation of less than 180° from one another), as shown in FIG. 9-3. The V-shaped orientation of the first and second contact members 304, 306 may provide a tactile guide for a user to place their finger 10 on the first and second contact members 304, 306 correctly aligned with the axis 308 of rotation. The V-shaped orientation of the first and second contact members 304, 306 may, therefore, become an alignment system for a user. In some embodiments, the V-shaped orientation of the first and second contact members 304, 306 may be a restraining system that limits the movement of a user's finger 10 laterally relative to the compliance tactile feedback device 300.

Once the finger 10 is in contact with the first and second contact members 304, 306 oriented in a V-shape relative to one another, the first and second contact members 304, 306 may be tilted away from the finger 10 to simulate a compliant surface and/or object. The user may perceive a compliant surface due at least partially to the downward tilting of the first and second contact members 304, 306 because the contact area spread rate is initially greater when starting from a V-shaped orientation than the 180° orientation depicted in FIG. 9-1. The downward tilt of the first and second contact members 304, 306 may also increase the contact area between the finger 10 and the first and second contact members 304, 306 as the angle between the first and second contact members 304, 306 decreases. This may result in additional tactile cues (e.g., skin stretch of the finger 10) to the user that enhance the simulation of a compliant surface and/or object.

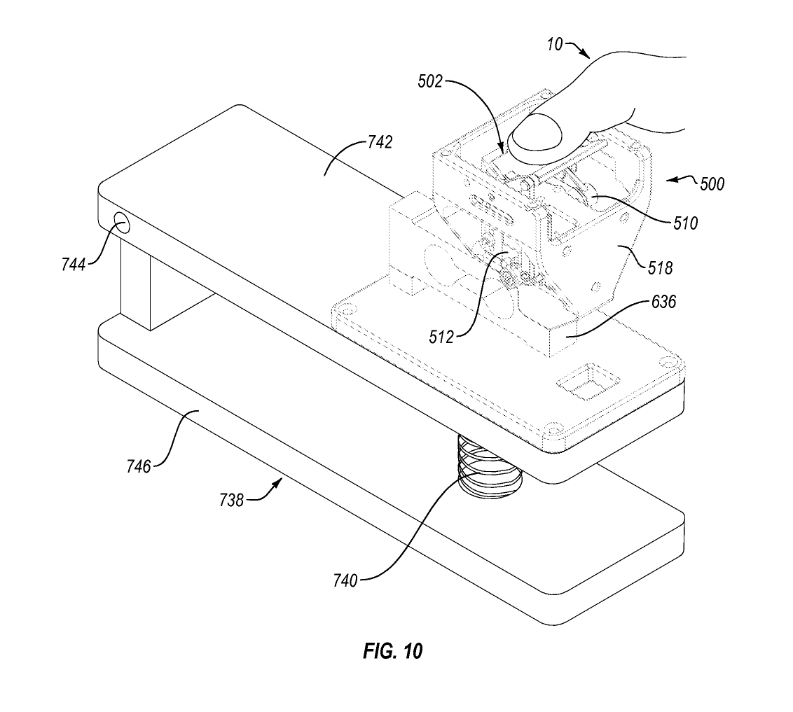

At least one embodiment of a compliance tactile feedback device as described herein may render compliance values of about 150 N/m up to about 1600 N/m. At least one embodiment of a compliance tactile feedback device may replicate values greater than about 1600 N/m, however as stiffness values exceed 1600 N/m, a user's ability to discern the feedback begins to diminish, but rigid (very stiff) surfaces can be portrayed by simply not actuating the contact surface 302. In order to better render higher compliance (lower stiffness) objects, such as materials with stiffness values of about 150 N/m or less, a compliance tactile feedback device may include a compressible assembly as shown schematically in FIGS. 2, 3, and in the device shown in FIG. 10. FIG. 10 depicts the compliance tactile feedback device 500 of FIG. 8, for example, mounted on a force sensor 636 that is in turn mounted on a compressible assembly 738.

The compressible assembly 738 of FIG. 10 may include a spring 740 that allows resilient displacement of the contact surface 502. In the depicted embodiment, the compressible assembly 738 also includes a lever arm 742 pivotally connected at a hinge 744 to a base 746. The compressible assembly 738 may, in other embodiments, be disposed at least partially within the housing 518 and enable the displacement of the contact surface 502 relative to the housing 518. For example, the spring 740 may be disposed beneath the actuators 510, 512 of the compliance tactile feedback device 500 and in contact with the housing 518. In such an embodiment, the compressible assembly may thereby allow displacement of the contact surface 502 relative to the housing 518. In yet other embodiments, the compressible assembly may include a compressible fluid to allow displacement of the contact surface 502. In still further embodiments, the compressible assembly 738 may include other compressible features.

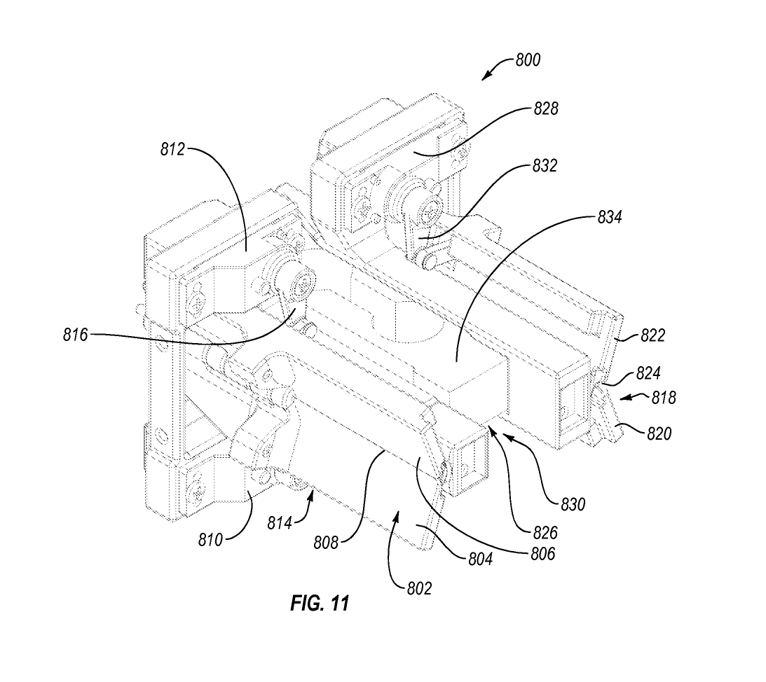

FIG. 11 depicts yet another embodiment of a compliance tactile feedback device in accordance with the present disclosure. The compliance tactile feedback device 800 of FIG. 11 includes a first contact surface 802 and a second contact surface 818 oriented in substantially opposite directions. Each of the first contact surface 802 and the second contact surface 818 may move to communicate tactile compliance information to a user. The substantially oppositely oriented first and second contact surfaces 802, 818 provide a user with compliance information upon compression between two fingers, such as a thumb and forefinger, of an object in a remote or virtual environment. A user may understand the information as a single percept while using two fingers in contact with the two contact surfaces 802, 818, communicating more information to the user about the object.

The compliance tactile feedback device of FIG. 11 includes two contact surfaces 802, 818 that include a pair of contact members in each, such as first and second contact members 804, 806 in the first contact surface 802 and third and fourth contact members 820, 822 in the second contact surface 818. The first and second contact members 804, 806 in the first contact surface 802 may be connected about a first axis 808 and may rotate relative to the first axis 808 and, therefore, one another. The third and fourth contact members 820, 822 in the second contact surface 818 may also be connected about a second axis 824 and may rotate relative to the second axis 824 and, therefore, one another. The first and second contact members 804, 806 of the first contact surface 802 may each be moved by first and second actuators 810, 812 respectively. The third and fourth contact members 820, 822 of the second contact surface 818 may each be moved by third and fourth actuators 826, 828 respectively (third actuator 826 not visible in FIG. 11). In other embodiments, the first contact surface 802 and/or the second contact surface 818 may be associated with only a single actuator, as described in connection with FIGS. 6 and 7. For example, in such an embodiment, a first actuator may move both the first and second contact members 804, 806 in the first contact surface 802. In other embodiments, a single actuator could also be used to actuate all four contact members 804, 806, 820, 822.

Referring again to FIG. 11, the first and second contact members 804, 806 may be connected to the first and second actuators 810, 812 by first and second mechanical linkages 814, 816 respectively. The first mechanical linkage 814 may translate motion of the first actuator 810 to move the first contact member 804. The second mechanical linkage 816 may translate motion of the second actuator 812 to move the second contact member 806. Similarly, the third and fourth contact members 820, 822 may be connected to the third and fourth actuators 826, 828 (third actuator 826 not visible in FIG. 11) by third and fourth mechanical linkages 830, 832 (third mechanical linkage 830 not visible in FIG. 11).

The first contact surface 802 and second contact surface 818 may each receive a force applied by a user's fingers as described in relation to FIGS. 9-1 through 9-3. A force sensor 834 may measure the force applied to calculate a rate and amount of movement of the first and second contact members 804, 806 and a rate and amount of movement of the third and fourth contact members 820, 822. The rate and amount of movement of each pair of contact members may be the same or may be different. For example, the first and second contact members 804, 806 may move with the same angular rate and amount of movement for a given force or may move by a different rate and amount from one another. The third and fourth contact members 820, 822 may move with the same rate and amount of movement for a given force or may move by a different rate and amount from one another. In another example, all of the contact members 804, 806, 820, 822 may move in the same rate and amount as each other. In yet another example, all of the contact members 804, 806, 820, 822 may each move by different rates and amounts as each other.

It should be understood that a compliance tactile feedback device having multiple contact surfaces, such as that depicted in FIG. 11, may also be employed in conjunction with a compressible assembly (as depicted schematically in FIG. 3) similar to that described in relation to FIG. 10 or a housing such as that described in relation to FIG. 8. The elements of each embodiment described may be used in combination with the elements of other embodiments or variants described herein.

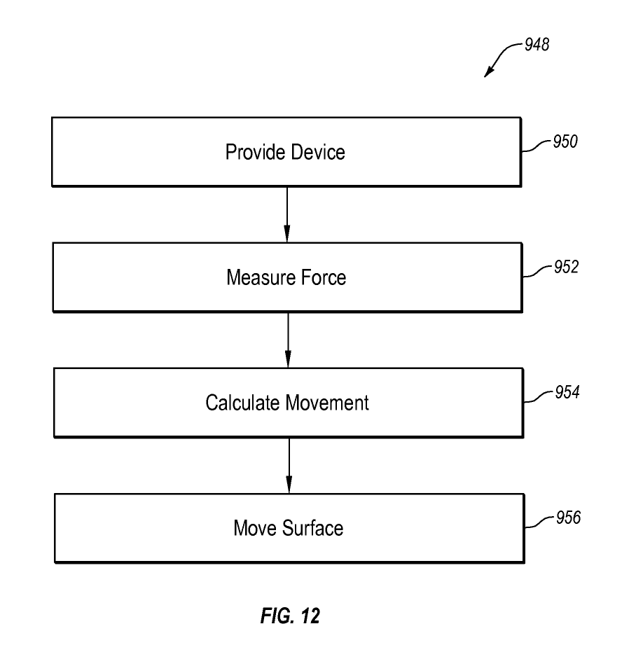

A method of communicating tactile compliance information to a user is also presented herein. FIG. 12 illustrates a method 948 including providing (950) a compliance tactile feedback device as described herein. The device or associated force sensor may measure (952) a force applied to a contact surface of the device. Using the force applied to the surface of the device, a rate and amount of movement of the contact surface may be calculated (954) based on a compliance value of the remote or virtual surface replicated by the device. The contact surface of the device may then move (956) in accordance with the calculated rate and amount of displacement.

In other embodiments, the method 948 may include rapidly moving the contact surface in response to the force applied to the contact surface of the device. For example, the rate and amount of movement of the contact surface may be a relatively high rate and low displacement, resulting in a vibrational movement of the contact surface. The frequency may increase or decrease relative to the compliance of the simulated material and/or object. In yet other embodiments, the method 948 may also include calculating a primary rate and amount of movement of the contact surface based at least partially upon the compliance of a primary material of a simulated or remote surface and/or object and calculating a secondary rate and amount of movement of the contact surface based at least partially upon the compliance of a secondary material of the simulated or remote surface and/or object.

For example, the simulated or remote surface and/or object may be a dual-density surface and/or object with a primary compliance and a secondary compliance. The contact surface may move with a primary rate and amount of movement until the secondary material is simulated, at which point, the contact surface may move with a secondary rate and amount of movement.

In some embodiments, the tilting plate compliance display can also be operated in passive or playback mode without utilizing any integrated force or displacement sensors. In this mode, the display can be fixed to a stationary object, built into another device, or mounted on a user's finger. In this mode, the contact members are driven based on external information obtained from a virtual or remote environment and/or the contact members can be driven based on a predetermined sequence of motions that represent experiences encountered by the user. For example, the passive motion of contact members can be implemented to replicate changes in the compliance or motion of a beating heart or vein or the compliance of a virtual/remote object which their mechanical properties alter through time (as opposed to changes that may only occur as a result of changes in the user's applied force). As another example, time-dependent behaviors of viscoelastic materials such as creep (material relaxation over extended loading periods) or relaxation (unloading over a period of time) can be also displayed by this mode/method.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 10%, within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A tactile feedback device, the device comprising:
a housing;
a plurality of contact members connected about an axis and to the housing, the plurality of contact members forming at least one contact surface;
an actuator configured to move at least one of the plurality of contact members; and
a linkage configured to translate movement from the actuator to the at least one of the plurality of contact members.

2. The device of claim 1, wherein the housing is disposed on a surface.

3. The device of claim 1, wherein the housing is disposed on a moveable member.

4. The device of claim 1, wherein the plurality of contact members are pivotally connected to the housing.

5. The device of claim 1, wherein the plurality of contact members are configured to pivot independently about the axis.

6. The device of claim 1, further comprising a second actuator configured to move at least one of the plurality of contact members.

7. The device of claim 1, further comprising a force sensor in communication with the one or more contact members.

8. The device of claim 1, wherein at least one of the plurality of contact members is rigid.

9. The device of claim 1, wherein at least one of the plurality of contact members is resilient.

10. The device of claim 1, further comprising a compressible assembly connected to the housing such that the compressible assembly is compressible in a direction substantially perpendicular to the at least one contact surface.

11. The device of claim 10, wherein the compressible assembly comprises a spring.

12. The device of claim 10, wherein the compressible assembly comprises a compressible fluid.

13. A tactile feedback device, the device comprising:
a housing;
a first pair of contact members pivotally connected to one another and connected to the housing, the first pair of contact members defining a first contact surface;
a second pair of contact members pivotally connected to one another and connected to the housing, the second pair of contact members defining a second contact surface; and
a first actuator configured to move at least one of the contact members; and
a second actuator configured to move at least one of the contact members.

14. The device of claim 13, wherein the first contact surface and second contact surface are oriented in substantially opposite directions.

15. The device of claim 13, wherein the actuator is configured to move the first pair of contact members.

16. The device of claim 13, further comprising a third actuator configured to move at least one of the contact members.

17. The device of claim 13, further comprising a second actuator configured to move the second pair of contact members.

18. A method of communicating tactile information, the method including:
providing a tactile feedback device comprising:
a housing,
a first contact member and a second contact member connected to the housing, the first contact member and second contact member of contact members forming a contact surface,
an actuator configured to move the first contact member, and
a linkage configured to translate movement from the actuator to the first contact member; and
moving the first contact member according to a first rate and an amount of movement provided.

19. The method of claim 18, the tactile feedback device further comprising a force sensor configured to measure a force applied to the contact surface, the method further comprising measuring a force applied to the contact surface and calculating the first rate and the amount of movement of the first contact member based at least partially upon the force.

20. The method of claim 19, wherein the device further comprises a compressible assembly.

21. The method of claim 19, further comprising calculating a second rate and amount of movement of the second contact member based at least partially upon the force, and moving the second contact member according to the second rate and amount of movement calculated.
